(19) United States
(12) Patent Application Publication
(10) Pub. No.: US 2007/0088107 A1
(43) Pub. Date: Apr. 19, 2007

(54) Production and use of polycarbonates with special purified, oligomeric epoxy resins

(76) Inventors: Alexander Meyer, Dusseldorf (DE); Frank Buckel, Krefeld (DE); Wolfgang Ebert, Krefeld (DE)

Correspondence Address: BAYER MATERIAL SCIENCE LLC, 100 BAYER ROAD, PITTSBURGH, PA, 15205, US

(21) Appl. No.: 11/545,394

(22) Filed: Oct. 10, 2006

(30) Foreign Application Priority Data
Oct. 13, 2005 (DE) 102005048954.0

(51) Int. Cl. C08K 5/15

(52) U.S. Cl. 524/114

(57) ABSTRACT

A thermoplastic composition having improved rheological and optical properties containing aromatic polycarbonate and an oligomeric epoxy resin is disclosed. The epoxy resin that conforms to formula (I) 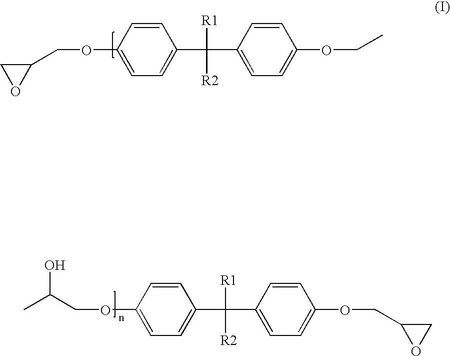
wherein R¹, R² mutually independently denote H, C₁-C₁₂ alkyl, cyclic C₅-C₁₂ alkyl, phenyl or benzyl groups and n is an integer of 0 to 20, contains no more than 0.1% water. A process for purifying the epoxy is also disclosed

### FIELD OF THE INVENTION

The invention concerns thermoplastic compositions and more particularly polycarbonate compositions suitable for molding and extrusion that contains an epoxy compound.

### TECHNICAL BACKGROUND OF THE INVENTION

The processing of polycarbonates requires them to have particularly good flow characteristics. The flow of polycarbonate may be improved by various measures. The simplest way is to reduce the molecular weight—although this is associated with a deterioration in mechanical properties such as e.g. impact strength and in particular notched impact strength.

The flowability of polycarbonate may also be increased using low-molecular-weight additives. JP 2001226576 disclosed a polycarbonate having a low molecular weight added to a polycarbonate having a higher molecular weight. As a general rule, however, these low-molecular-weight additives may lead to a reduction in the optical quality, such as e.g. transmission or yellowness index (YI). Furthermore, low-molecular-weight additives often cause deposits on the injection-molded parts (plate out), thereby reducing the quality of the injection moldings. These additives may also lead to a sharp deterioration in the mechanical properties of the polycarbonates, as a consequence of which an important material advantage for the use of polycarbonate is lost.

Using special comonomers, the flowability of the resulting copolycarbonates may likewise be increased in comparison with conventional bisphenol A (BPA) polycarbonate. This is frequently associated with a change in the range of properties, however. Thus the glass transition temperature may be reduced markedly. As described by J. Schmidhauser and P. D. Sybert in J. Macromol. Sci. —Pol. Rev. 2001, C41, 325-367, the use of bis-(4-hydroxyphenyl)dodecane leads to an extremely low glass transition temperature of 53° C. in the resulting polycarbonate. The copolymerization of BPA with various aliphatic dicarboxylic acids, as described for example in U.S. Pat. No. 5 321 114, likewise leads to a lowering of the glass transition temperature.

Although the epoxy resin purified by the process according to the invention is used as a flow control agent in the polycarbonate, it has only a negligible influence on the glass transition temperature.

A further possibility for improving the flowability is achieved by the incorporation of particular chain terminators. Thus the use of long-chain alkyl phenols is disclosed in WO 2002/038647.

As a general rule, these modified polycarbonates are very laborious to produce and are therefore associated with high investment costs. The special comonomers and/or molecular weight regulators are frequently not freely available and must be synthesised by laborious means.

Another possibility for improving the theological properties of polycarbonate is the use of polycarbonate blends, i.e. the mixing of polycarbonates with other polymers such as polyesters for example. Such blends are described in JP 2002012748, for example.

The properties of these blends are in some cases quite different from standard bisphenol A-based polycarbonate, however, and so they cannot necessarily be used for the same applications. For instance, in some cases the thermal stability, optical properties, heat resistance (reduction of the glass transition temperature) and mechanical properties differ markedly from those of standard polycarbonate.

Mixtures of epoxy resins with thermoplastics such as e.g. poly(methyl methacrylate) and/or polycarbonate have already been described by E. M. Woo, M. N. Wu in Polymer 1996, 37, 2485-2492. However, these epoxy resins undergo no special purification as in the composition according to the invention. E. M. Woo and M. N. Wu report on a damaging influence on polycarbonate by, in particular, epoxy resins containing hydroxyl groups. Thermal loading on the blend leads to a reduction in the molecular weight. This damaging influence is not observed or is significantly reduced through the purification process according to the invention, which the epoxy resins undergo before being used in the polycarbonate.

In U.S. Pat. No. 3,978,020 particular epoxy compounds are used in combination with phosphorus compounds. These epoxy compounds do not correspond to the epoxy resins having the general formula (I) of the present invention.

Mixtures of epoxy resins which also come under the general formula (I) of the present invention with aromatic polycarbonates are known from EP-A 718 367. These are characterised by high corrosion resistance. In EP-A 718 367 the proportion of epoxy resins used in the polycarbonate is ≦0.5 wt. %. The improvement in flowability is not described.

In order to achieve the influence according to the present invention a minimum quantity of ≧0.7 wt. % of the epoxy resin having the general formula (I) is necessary, however, which in turn may only be incorporated into the composition without damage of the polycarbonate if the epoxy resin has been purified according to the present invention.

In DE-A 2 400 045 aromatic or aliphatic epoxy compounds having the following formula (II) are used: 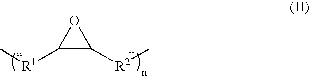
wherein R¹ and R² are aliphatic or aromatic radicals. The corresponding mixtures are hydrolytically stable. The epoxy resins described in DE-A 2 400 045 differ structurally from the epoxy resins according to the invention. The use of the epoxy resins described in DE-A 2 400 045 for flow improvement in polycarbonate is not described.

DE-A 2019325 describes polycarbonate mixtures consisting of polycarbonate and epoxy group-containing pigments. The epoxy compounds are used in quantities of 5 to 100 wt. % based on the pigment content. The epoxy resins used here are contained in larger quantities than the quantities used in the composition according to the invention and were not subjected to a prior purification process. As a consequence, improved flow characteristics in the polycarbonate mixture are. not described in DE-A 201935.

Polycarbonates filled with TiO₂ and containing an epoxy group-containing vinyl polymer are known from DE-A 2327014, The epoxy resins used here do not correspond to those described here according to formula I. An improvement in the flow characteristics is not described.

In the compositions described in the prior art, although the flow characteristics of the particular polycarbonate are improved in some cases, at the same time the optical properties such as transparency, transmission and yellowness index (YI) and also other properties such as plate-out behavior deteriorate. Such additives in the polycarbonate are therefore unsuitable for the production of large-format, transparent injection-molded articles such as glazing products. Additives which both improve the flow characteristics of the polycarbonate composition and at the same time do not impair the optical properties of the polycarbonate are therefore hitherto unknown in the prior art.

### SUMMARY OF THE INVENTION

A thermoplastic composition having improved rheological and optical properties containing aromatic polycarbonate and an oligomeric epoxy resin is disclosed. The epoxy resin that conforms to formula (I) 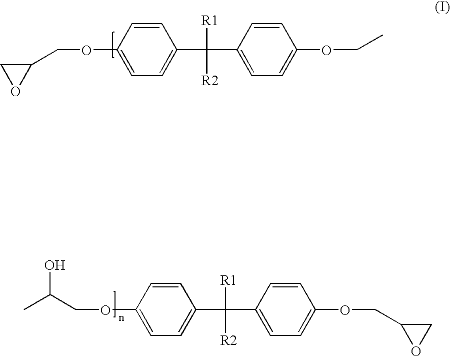
wherein R¹, R² mutually independently denote H, C₁-C₁₂ alkyl, cyclic C₅-C₁₂ alkyl, phenyl or benzyl groups and n is an integer of 0 to 20, contains no more than 0.1% water. A process for purifying the epoxy is also disclosed.

### DETAILED DESCRIPTION OF THE INVENTION

The invention provides a polycarbonate composition which demonstrates improved flow characteristics in comparison to standard bisphenol A polycarbonate whilst retaining the optical properties and with no reduction in molecular weight. Surprisingly it has been found that this object may be achieved through polycarbonate compositions with epoxy resins which have either been purified by a special purification process or have previously been dried and thus have a water content of less than 0.1 wt. %.

The invention also provides a process for purifying oligomeric epoxy resins having the general formula (I) 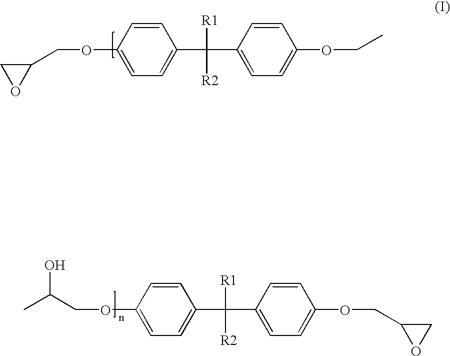
wherein

R¹, R² mutually independently stand for H, C₁-C₁₂ alkyl, cyclic C₅-C₁₂ alkyl, phenyl or benzyl groups and

n is an integer of 0 to 20,

comprising drying the residue to water content of less than 0.1% relative to the weight of the residue. The drying is advantageously performed at temperatures in the range of 80 to 150° C. and under a pressure in the range of 0.1 to 1 bar.

The invention also provides a preferred process for purifying oligomeric epoxy resins having the general formula (I) 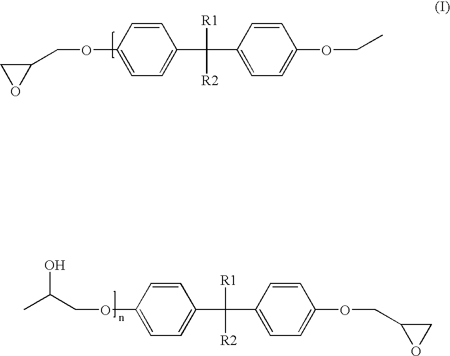
wherein

R¹, R² mutually independently stand for H, C₁-C₁₂ alkyl, cyclic C₅-C₁₂ alkyl, phenyl or benzyl groups and

n is an integer of 0 to 20

comprising the following steps:

(a) dissolving a compound conforming to formula (I) in an organic solvent,
(b) adding an adsorbent to the solution to obtain a mixture,
(c) stirring the mixture for 0.2 to 24 hours,
(d) filtering the stirred mixture obtained in (c) through a particle filter having pores size of 0.1 to 30 μm in diameter, to obtain a filtrate and a residue,
(e) removing the solvent from the filtrate obtained in step (d) and
(f) drying the residue to a water content of less than 0.1% relative to its weight.

In the purification process according to the invention step (f) is advantageously performed at temperatures in the range from 80 to 150° C. and under a pressure from 0.01 to 1 bar.

Acid, basic and/or neutral aluminium oxide powder having an activity grade in the range from 1 to 2 is advantageously used as an adsorbent in the purification process according to the invention.

The invention also provides the use of the oligomeric epoxy resin purified according to the invention as an additive for polycarbonate.

The use of the oligomeric epoxy resin purified according to the invention as a flow control agent in polycarbonate is advantageous.

The epoxy resins having the general formula (I) 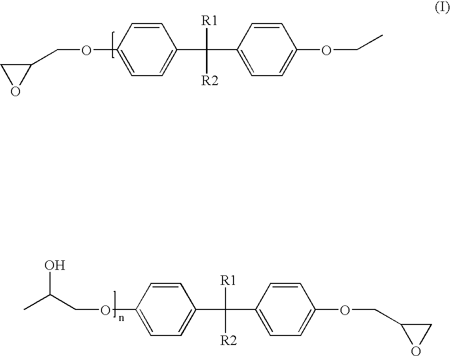
are compounds in which R¹, R² mutually independently stand for H, C₁-C₁₂ alkyl, cyclic C₅-C₁₂ alkyl, phenyl and/or benzyl groups. R¹ and R² are preferably mutually independently selected from the group comprising H, CH₃- and cyclohexyl groups. The index n is an integer selected such that the weight average molecular weight of the compound is 700 to 10,000, preferably 700 to 4000. Thus n is in the range of 0 to 20, preferably 1 to 9, particularly preferably 1 to 4. Commercially available epoxy resins having the general formula (I), such as Epikote® 1001 I from Hannf+Nelles GmbH Co. KG (epoxy content 2000 to 2220. mmol/kg; viscosity at 25° C. 5.3 to 6.8 mPas), frequently contain impurities. Impurities are understood to be water contents of >0.1% and residues arising from the epoxy resin production process, such as e.g. traces of HCl. After incorporation of the epoxy resin—particularly in quantities in the range from a few ppm by weight—these impurities may damage polycarbonate.

To eliminate the impurities, the epoxy resin having the formula (I) is dissolved in an organic solvent. The organic solvents are selected from the group comprising acetone, dichloromethane, chloroform, ethyl acetate and diethyl ether. Acetone is used as the preferred organic solvent (process step (a)). The oligomeric epoxy resin dissolved in the organic solvent is then reacted with an adsorbent. The adsorbents are selected from the group comprising zeolites, silica gel and aluminium oxides. Preferred adsorbents are selected from the group comprising neutral, acid and/or basic aluminium oxide, preferably from neutral or basic aluminium oxide having an activity grade in the range from 1 to 2. Preferred adsorbents are neutral or basic aluminium oxide (process step (b)) having an activity grade of 1 to 2. Following the addition of the adsorbent, the mixture of dissolved epoxy resin and adsorbent is stirred for 0.2 to 24 hours. Stirring is preferably carried out for 0.5 to 2 hours (process step (c)). In a further process step (process step (d)) the adsorbent is then filtered off from the solution and the filtrate is collected. Particle filters are used for filtration. The pore size of the particle filters is determined by the particle size of the adsorbent used. To ensure that no adsorbent particles remain in the filtrate, the pore size of the particle filter is chosen to be smaller than the adsorbent particle size. A pore size of 0.1 to 10 μm with an adsorbent particle size of 20 to 200 μm is preferred. The solvent is then removed from the filtrate separated in this way (process step (e)). Removal of the solvent takes place by the conventional methods known to the person skilled in the art such as evaporation, preferably under application of a vacuum. The residue remaining after process step (e) is then dried (process step (f)). The residue is, preferably dried at temperatures in the range from 80 to 150° C. and under a pressure in the range from 0.01 to 1 bar. Temperatures in the range from 100 to 140° C. and a pressure in the range from 0.01 to 0.5 bar are particularly preferred. Drying is performed until the water content is <0.1%, the water content measurement being performed with an HG 53 Halogen Moisture Analyzer.

In accordance with the invention the epoxy resins purified or dried in this ways used as additives in polycarbonate. The use of the epoxy resins as flow control agents in polycarbonate is particularly preferred.

The composition according to the invention contains 95.0 to 99.3 wt. % of aromatic polycarbonate, and 0.7 to 5.0 wt. % of oligomeric epoxy resin treated by the purification process according to the invention or dried epoxy resin having the formula (I). 99.0 to 97.0 wt. % of aromatic polycarbonate and 1.0 to 3.0 wt. % of the oligomeric epoxy resin purified by the process according to the invention or a dried epoxy resin having the formula (I) with a water content of less than 0.1 wt. % are preferred. This oligomeric dried or purified epoxy resin having the formula (I) preferably has an average molecular weight Mn (number average) of 700 to 10,000, particularly preferably 700 to 4000 (measured by means of gel permeation chromatography with polystyrene standard and THF as solvent at room temperature). The epoxy resins having the formula (I) are known and may be produced from bisphenol A and epichlorohydrin as described in Kirk Othmer “Encyclopedia of Chemical Technology” 4^{th} Ed., Vol. 9, p. 731 ff.

The aromatic polycarbonates used in the polycarbonate mixtures according to the invention may be both homopolycarbonates and copolycarbonates; the polycarbonates here may be linear or branched by known means.

As described in DE-A 2 119 799, the production of polycarbbnates takes place using phenolic terminal groups by the interfacial polycondensation process or by the process in the homogeneous phase. Aromatic polycarbonate produced by either process may be used in the composition according to the invention.

The production of polycarbonate by the interfacial polycondensation process is described in the prior art such as in H. Schnell, Chemistry and Physics of Polycarbonates, Polymer Reviews, Vol. 9, Interscience Publishers, New York. 1964 p. 33 ff. and in Polymer Reviews, Vol. 10, “Condensation Polymers by Interfacial and Solution Methods”, and in Paul W. Morgan, Interscience Publishers, New York 1965, Chapter VIII, p. 325.

However, the aromatic polycarbonates for the composition according to the invention may also be produced from diaryl carbonates and aromatic dihydroxy compounds by the known polycarbonate method in the melt, known as the melt interesterification method, as described for example in WO-A 01/05866 and WO-A 01/05867. At the same time, however, aromatic polycarbonates from interesterification methods (acetate method and phenyl ester method) as described for example in U.S. Pat. No. 3,494,885, U.S. Pat. No. 4,386,186, U.S. Pat. No. 4,661,580, U.S. Pat. No. 4,680,371 and U.S. Pat. No. 4,680,372, EP-A 26 120, EP-A 26 121, EP-A 26 684, EP-A 28 030, EP-A 39 845, EP-A 91 602, EP-A 97 970, EP-A 79 075, EP-A 146 887, EP-A 156 103, EP-A 234 913 and EP-A 240 301, and in DE-A 1 495 626 and DE-A 2 232 977, may also be used.

The process according to the invention for producing the composition takes place by adding the epoxy resin to the polycarbonate. The epoxy resin may be added during the workup phase after polymer synthesis or subsequently, for example by subsequent addition in a compounding extruder.

If compounding is chosen, the epoxy resins or mixtures thereof may be added to the compounding extruder in bulk or as a masterbatch of 0.5 to 20 wt. %, preferably 1 to 5 wt. % of epoxy resin in a polycarbonate. Other additives may optionally be added in the same processing step, mixed together with the epoxy resin or the masterbatch thereof.

If the workup step is chosen for adding the epoxy resin, the resin, optionally with other additives, may be admixed to the polycarbonate solution to be concentrated to small volume.

If the concentration of the polycarbonate solution from the polycarbonate production process takes place using an evaporation extruder, the same process as for compounding may be used, or the addition of the resin, to which other additives have been added, may take place by means of masterbatches through an ancillary extruder and into the evaporation extruder.

The addition as a masterbatch preferably takes place as a 0.5 to 20 wt. %, preferably 1 to 5 wt. % masterbatch of the dried or purified, oligomeric epoxy resin in a thermoplastic polycarbonate, wherein the polycarbonate into which the masterbatch is incorporated is in the form of its melt or a solution. Preferably the amount and the concentration of the Masterbatch used is such that the resulting composition comprises 5.0 to 0.7 wt. % of an oligomeric epoxy resin conforming to formula (I).

The thermoplastic polycarbonate used as the masterbatch preferably corresponds to the polycarbonate used for the composition according to the invention or may differ therefrom. Other thermoplastic polycarbonates which may be used as the masterbatch are modified polycarbonates, such as e.g. copolycarbonates. The use of bisphenol A polycarbonate in the masterbatch is preferred. If the oligomeric epoxy resin is to be incorporated into a polycarbonate solution, organic solvents such as dichloromethane or mixtures of dichloromethane and chlorobenzene are used for the aromatic polycarbonate. Dichloromethane is preferred as the solvent. The compositions according to the invention may additionally also contain further additives. Such additives are flame retardants, release agents, antistatics, UV stabilizers, heat stabilizers, such as are known for aromatic polycarbonates, in the conventional amounts for polycarbonates. 0.1 to 1.5 wt. %, based on the polycarbonate used, are preferred. Examples of such additives are release agents based on stearic acid and/or stearic alcohol, particularly preferably pentaerythritol stearate, trimethylol propane tristearate, pentaerythritol distearate, stearyl stearate, and glycerol monostearate, and heat stabilizers based on phosphanes and phosphites.

The present invention thus also provides compositions containing the aromatic polycarbonate, the purified oligomeric epoxy resin and at least one additional additive selected from the group comprising release agents, flame retardants, antistatics, UV stabilizers, heat stabilizers.

The compositions according to the invention may be processed under conventional conditions on conventional machinery into any type of molding such as sheets, films, filaments, lenses, discs, equipment housings. The polycarbonates according to the invention may be processed on all equipment suitable for thermoplastic molding compositions. The polycarbonates according to the invention must be predried as is conventional for polycarbonate. The polycarbonates according to the invention may be molded in a further processing step by any conventional process such as injection molding and extrusion or injection blow molding. A review of these processes is provided for example in Kunststoffhandbuch 1992, Polycarbonate, Polyacetale, Polyester, Celluloseester, Ed. W. Becher, p. 211 ff. The present invention also provides the polycarbonates as obtained by the process according to the invention and their use to produce extrudates and moldings, in particular those for use in the transparent area, most particularly in the area of optical applications such as e.g. sheets, multi-wall sheets, glazing products, diffusers, lamp covers or optical data storage media, such as audio CDs, CD-R(W)s, DVDs, DVD-R(W)s, minidiscs in their various read-only, writable or optionally rewritable versions.

The present invention likewise provides the extrudates and moldings obtained from the polymer according to the invention.

Other applications, without however restricting the subject of the present invention, are, for example:
1. Safety glass, which is known to be needed in many areas of buildings, vehicles and aircraft, and as visors for helmets.
2. Films.
3. Blow moldings (see also U.S. Pat. No. 2,964,794), for example 1 to 5 gallon water bottles.
4. Translucent sheets, such as solid sheets or in particular twin-wall sheets, for example for covering buildings such as stations, greenhouses and lighting installations.
5. Optical data storage media, such as audio CDs, CD-R(W)s, DCDs, DVD-R(W)s, minidiscs and subsequent developments thereof.
6. Traffic light housings or road signs.
7. Foams with an open or closed and optionally printable surface.
8. Filaments and wires (see also DE-A 11 37 167).
9. Lighting applications, optionally using glass fibres for applications in the a translucent sector.
10. Translucent formulations containing barium sulfate and/or titanium dioxide and/or zirconium oxide or organic polymeric acrylate rubbers (EP-A 0 634 445, EP-A 0 269 324) for producing translucent and light-scattering molded parts.
11. Precision injection moldings, such as holders, e.g. lens holders; polycarbonates having a content of glass fibres and optionally additionally containing 1-10 wt. % of molybdenum disulfide (based on the complete molding composition) are optionally used here.
12. Optical device components, in particular lenses for photographic and film cameras (DE-A 27 01 173).
13. Light carriers, in particular optical cables (EP-A 0 089 801) and lighting strips.
14. Electrical insulating materials for electrical cables and for connector housings and plug-in connectors, and for capacitors.
15. Mobile telephone cases.
16. Network interface devices.
17. Supports for organic photoconductors.
18. Lamps, headlamps, diffusers or internal lenses.
19. Medical- applications such as oxygenators, dialysis machines.
20. Food applications, such as bottles, tableware and chocolate molds.
21. Applications in the automotive sector, such as glazing products or in the form of blends with ABS as bumpers.
22. Sports articles such as slalom poles, ski boot clips.
23. Domestic items, such as kitchen sinks, washbasins, letterboxes.
24. Enclosures, such as electrical distribution cabinets.
25. Housings for electrical appliances such as toothbrushes, hairdryers, coffee makers, machine tools, such as drills, milling machines, planing machines and saws.
26. Washing machine portholes.
27. Protective goggles, sunglasses, optical correction spectacles and lenses.
28. Lamp covers.
29. Packaging films.
30. Chip boxes, chip carriers, boxes for Si wafers.
31. Other applications such as stable doors or animal cages.

The invention is further illustrated but is not intended to be limited by the following examples in which all parts and percentages are by weight unless otherwise specified.

### EXAMPLES

### Example 1

The BPA epoxy resin Epikote® 1001 (Hanf+Nelles GmbH Co. KG, Germany; epoxy content 2000-2220 mmol/kg; viscosity at 25° C. 5.3 to 6.8 mPas) was dried at a temperature of 100° C. and under a pressure of 0.5 mbar for 7 hours. Determination of the residual moisture was carried out by means of the amount of weight loss when heated to 180° C., using an HG 53 Halogen Moisture Analyzer, and gave a result of 0.09 wt. %. 40 g of the epoxy resin pretreated in this way were pulverised and mixed with 3960 g of polycarbonate powder (Makrolon® 2808, Bayer MaterialScience AG) in a drum hoop mixer (corresponding to 1 wt. % epoxy resin). This mixture was introduced into a compounding extruder (ZSK 32/3; screw compounder with an external screw diameter of 32 mm) and granulated. The granules were injection molded under the conventional conditions for Makrolon® 2808 (melt temperature 295° C.; extruder speed 97 rpm) to form sheets (150×100×3.2 mm) in optical quality. The transmission of these sheets was 88.2%, the YI difference (yellowness index) and haze difference compared with pure Makfolon® 2808 containing no further additives were 2 and 0.9% respectively.

The melt viscosity of these sheets was tested by measuring the zero shear-rate viscosity using a cone and plate viscometer and was 1070 Pa.s at 270° C. and 425 Pass at 300° C. (the melt viscosities were determined using a Physica UDS 200 rotational/oscillating rheometer. A cone and plate geometry was used. The cone angle is 2° and the cone diameter 25 mm (MK 216). The specimens are press molded at 230° C. in a heating press-to form thin films. Isothermal frequency spectra were recorded at the specified temperatures).

The molecular weight average of these sheets was determined by GPC at room temperature, calibrated on BPA-PC, and gave a result of M_{w}=27.6 kg/mol.

According to DSC, the glass transition temperature likewise determined for these sheets was 146° C. (The glass transition temperature was measured in a heat flow differential calorimeter (Mettler) at 20 K/min in standard aluminium crucibles across a temperature range from 0° C. to 250° C. in the first and 0 to 300° C. in the second heating phase. The value determined in the second heating phase was specified).

### Example 2

An epoxy resin pretreated as in Example 1 is added in an amount of 2 wt. % to polycarbonate (Makrolon® 2808) as described in Example 1.

The glass transition temperature of the mixture is 143° C. The zero shear-rate viscosity is 815 Pa.s at 270° C. (287 Pa.s at 300° C.) and thus significantly lower than conventional Makrolon® 2808 (see Table 1).

### Example 3 (Comparative Example)

The same process is followed in comparative example 3 as in examples 1 and 2 according to the invention, with the difference that the Makrolon® 2808 used contains no epoxy resin having the general formula (I).

### Example 4 (Comparative Example)

In this comparative example the BPA epoxy resin Epikote® 1001 is incorporated into polycarbonate (Makrolon® 2808) in an amount of 1 wt. % without pretreatment.

The molecular weight distribution of the corresponding composition shows a clear reduction in the molecular weight of the polycarbonate (M_{w}=26,700 g/mol).

This confirms that when incorporating larger amounts, in other words the amounts according to the invention, it is necessary to carry out an appropriate pretreatment of the epoxy resin, since otherwise an unacceptable reduction in the molecular weight occurs.

With the exception of the MVR determination (melt volume rate measured at 300° C. and with a weight of 1.2 kg), the measurement results shown in Table 1 were performed exactly as in Example 1 on sheets (150×100×3.2 mm) in optical quality.

TABLE 1
Optical and rheological properties

| | | Zero shear- | | | | | | |
|---|---|---|---|---|---|---|---|---|
| | wt. % of | rate | | | | | | Molecular |
| Ex. | epoxy | viscosity | MVR | Transmission | Haze | | DSC | weight (M_{w}) |
| no. | resin | [Pa · s] | [cm³/10 min] | [%] | [%] | YI | Tg [° C.] | [g/mol] |
| 1 | 1 | 1070 | 11.0 | 88.2 | 1.1 | 3.9 | 146 | 27,600 |
| 2 | 2 | 815 | 13.1 | — | — | — | 143 | 28,100 |
| 3 | 0 | 1480 | 8.9 | 89.7 | 0.2 | 1.9 | 148 | 28,200 |

### Example 5

The BPA epoxy resin Epikote® 1001 (epoxy content 2000-2220 mmol/kg; viscosity at 25° C. 5.3 to 6.8 mPas) from a different batch from that in Examples 1, unlike the batch from Example 1, displayed a brown discoloration in a preliminary test (heat 1 wt. % in Makrolon® 2808 to 300° C. and hold at 300° C. for 10 min), even after drying. This other batch was purified as follows:

70 g of the BPA epoxy resin Epikote® 1001 were dissolved in 150 ml of acetone and 14 g of aluminium oxide were added (aluminium oxide 507-C-I neutral from Camag, Switzerland), the mixture was stirred for 6 h at room temperature, filtered under pressure through a polyamide filter (Sartolon polyamide, pore size 0.45 μm, from Sartorius AG, Germany), concentrated to low volume and dried at 80° C. Directly before being incorporated into polycarbonate, the purified Epikote® 1001 was dried as described in Example 1. The result of the preliminary test is now positive (no brown discoloration).

### Example 6 (Comparative Example)

In this comparative example the BPA epoxy resin Epikote® 1001 is incorporated into polycarbonate (Makrolon® 2808) in an amount of 0.4 wt. % without pretreatment.

The molecular weight distribution of the corresponding composition shows a clear reduction in the molecular weight of the polycarbonate (M_{w}=26800 g/mol). This confirms that also smaller amounts of epoxy resin are problematic when used without pre-treatment in polycarbonate.

### Example 7 (Comparative Example)

In this comparative example another epoxy compound is used which is different from formula (I) and thus is not matter of this invention.

In this comparative example the Bisphenol-A-diglycidylether (CAS-RN 1675-54-3; ABCR; lot 18-1-8-BS) is incorporated into polycarbonate (Makrolon® 280.8) in an amount of 0.1 wt. % without pretreatment.

Molecular weight (28200 g/mol) and melt viscosity (zero shear-rate viscosity using a cone and plate viscometer was 1426 Pa.s at 270° C. and 580 Pa.s at 300° C.) remained nearly unchanged compared to comparative example 3 when no additive is used.

This confirms that using epoxy compounds which are different from formula (I) and thus not matter of this invention result in no improvement of rheological properties.

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A process for purifying oligomeric epoxy resins having the general formula (I) 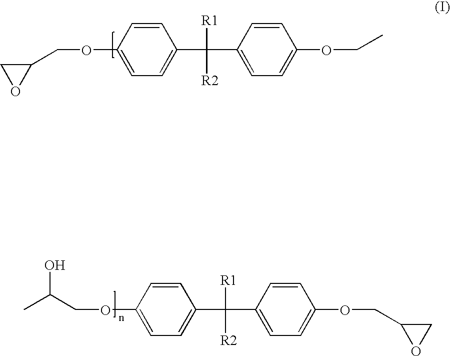
wherein
R¹, R² mutually independently stand for H, C₁-C₁₂ alkyl, cyclic C₅-C₁₂ alkyl, phenyl or benzyl groups and
n is an integer of 0 to 20,
comprising drying the epoxy resin to water content of less than 0.1% relative to the weight of the epoxy resin.

2. The process according to claim 1, wherein the drying is at 80 to 150° C. and under pressure of 0.1 to 1 bar.

3. A process for purifying oligomeric epoxy resins having the general formula (I) 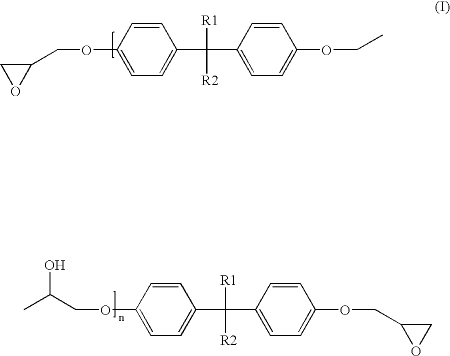
wherein
R¹, R² mutually independently stand for H, C₁-C₁₂ alkyl, cyclic C₅-C₁₂ alkyl, phenyl or benzyl groups and
n is an integer of 0 to 20,
comprising
(a) dissolving a compound conforming to formula (I) in an organic solvent,
(b) adding an adsorbent to the solution to obtain a mixture,
(c) stirring the mixture for 0.2 to 24 hours
(d) filtering the stirred mixture obtained in (c) through a particle filter having pores size of 0.1 to 30 μm in diameter to obtain a filtrate and a residue,
(e) removing the solvent from the filtrate obtained in step (d) and
(f) drying the residue to water content of less than 0.1% relative to the weight of the residue.

4. The process according to claim 3, wherein the drying is at 80 to 150° C. and under pressure of 0.1 to 1 bar.

5. The process- according to claim 3 wherein the absorbent is aluminium oxide powder having an activity grade of 1 to 2 .

6. A thermoplastic composition containing
95.0 to 99.3 wt. % of an aromatic polycarbonate and
5.0 to 0.7 wt. % of an oligomeric epoxy resin conforming to formula (I) of claim 1.

7. The composition according to claim 6 further containing at least one member selected from the group consisting of flame retardants, release agents, antistatics, UV stabilizers and heat stabilizers.

8. The composition according to claim 6 wherein R¹ and R² denote CH₃ groups and n is 1 to 9.

9. The composition according to claim 6 wherein n is 1 to 4.

10. An article of manufacture comprising the composition of claim 6.
